(19) United States
(12) Patent Application Publication
(10) Pub. No.: US 2014/0001945 A1
(43) Pub. Date: Jan. 2, 2014

(54) LIGHTING DEVICE

(71) Applicants: Shoji Yamamoto, Osaka-shi (JP); Sei Natsume, Osaka-shi (JP); Yoshiyuki Kitamura, Osaka-shi (JP)

(72) Inventors: Shoji Yamamoto, Osaka-shi (JP); Sei Natsume, Osaka-shi (JP); Yoshiyuki Kitamura, Osaka-shi (JP)

(73) Assignee: SHARP KABUSHIKI KAISHA, Osaka-shi, Osaka (JP)

(21) Appl. No.: 14/004,386

(22) PCT Filed: Apr. 11, 2012
(86) PCT No.: PCT/JP2012/059936

§ 371 Date: Sep. 10, 2013

(30) Foreign Application Priority Data
Apr. 12, 2011 (JP) 2011-088497

(51) Int. Cl. F21K 99/00

(52) U.S. Cl. CPC F21K 9/50
USPC 313/111; 313/110

(57) ABSTRACT

A lighting device includes: an LED module; a holding member which holds the LED module on its mount part, the mount part protruding in a direction of light emission from the LED module; and a light distribution lens which faces toward the mount part, the light distribution lens (i) receiving light emitted from the LED module and (ii) causing the light to travel to a first side to which the LED module emits the light and to a second side opposite to the first side.

### TECHNICAL FIELD

The present invention relates to a lighting device capable of lighting with a wide light distribution angle.

### BACKGROUND ART

Semiconductor light emitting elements, such as a light emitting diode (LED), directly convert electrical energy into light energy. Therefore, the semiconductor light emitting elements are more efficient and generate less heat when emitting light than fluorescent lamps and incandescent lamps such as a halogen lamp. The incandescent lamps convert electrical energy into heat energy and use radiation resulting from the heat. Therefore, the conversion efficiency of the incandescent lamps is low in principle. The fluorescent lamps convert electrical energy into discharge energy. Therefore, the conversion efficiency of the fluorescent lamps is also low. On the other hand, LEDs have a high conversion efficiency. Furthermore, the life of the LEDs is so long that the LEDs may be used semi-permanently, and the LEDs do not cause flickering unlike fluorescent lamps.

As described above, the LEDs are advantageous in that their life is long and they are power-saving. In recent years, such advantages of the LEDs have been attracting attention, and there have been developed lighting devices which use the LEDs as a light source instead of an incandescent lamp or a fluorescent lamp.

For example, Patent Literature 1 discloses an LED bulb which provides a substantially uniform brightness by attaching a diffusion sheet to the outer surface of a light-transmissive globe covering LEDs so that light emitted from the LEDs and entering the globe is diffused by the diffusion sheet.

According to the LED bulb, light emitted from each of the LEDs is diffused by the diffusion sheet attached to the globe, as described above. Because of such diffusion, each point on the globe where the light is diffused serves as a new light-emitting point. This makes it possible to achieve a substantially uniform brightness throughout almost the entire surface area of the globe, and thus gives less glare and discomfort to a person.

### CITATION LIST

### Patent Literature

Patent Literature 1
Japanese Patent Application Publication, Tokukai, No. 2008-91140 A (Publication Date: Apr. 17, 2008)

### SUMMARY OF INVENTION

### Technical Problem

Although the LEDs have the foregoing advantages, they have been used only in limited applications such as control panels for various devices and display devices for electric bulletin boards. There have been only a small number of cases where the LEDs are used for general lighting devices. This is because, although the LEDs have a very high brightness, light from a single LED shines on a very small area and thus the LEDs do not have a light-distribution property that general lighting devices are required to have.

In view of the circumstances, lighting devices using LEDs as a light source have been required to have an increased light-distribution property. That is, there has been a strong potential demand for realization of an LED bulb capable of lighting with a wide light distribution angle like those achieved by incandescent lamps and fluorescent lamps.

However, the lighting device described in Patent Literature 1 has the following problem. That is, although it is possible to cause the entire surface area of the globe to emit light having a substantially uniform brightness with the use of the diffusion sheet, since a substrate on which the LEDs are mounted is attached to a support that faces an opening in the globe which opens toward the base, light from the LEDs, which are highly-directional light sources, travels only in a direction opposite to the base. As a result, the only light that travels to the base side is a small part of the light diffused by the diffusion sheet. Therefore, according to the above-mentioned conventional lighting device, only a little light travels to the base side. Such a lighting device cannot shine sufficient light also to a side opposite to a side to which the LEDs emit light, i.e., to the backside of the lighting device. That is, such a lighting device is not capable of creating a wide angle of light distribution.

In view of the above problem, an object of the present invention is to provide a lighting device capable of lighting with a wide light distribution angle by shining light also to a side opposite to a side to which a light emitting element emits light.

### Solution to Problem

In order to attain the above object, a lighting device in accordance with the present invention includes: a light emitting element; a holding member which holds the light emitting element on its mount part, the mount part protruding in a direction of light emission from the light emitting element; and an optical member which faces toward the mount part, the optical member (i) receiving light emitted from the light emitting element and (ii) causing the light to travel to a first side to which the light emitting element emits the light and to a second side opposite to the first side.

According to the configuration, light emitted from the light emitting element is directly incident on a bottom surface of the optical member. The light emitting element is, for example, an LED, and its light-emitting surface has a narrow angle of light distribution. Therefore, light emitted from the light emitting element travels substantially straight toward the bottom surface of the optical member along the direction of light emission. The light, which has been incident on the bottom surface of the optical member, travels through the optical member and reaches a top surface opposite to the bottom surface.

The bottom surface and top surface of the optical member transmit or reflect light. They transmit or reflect light depending on the incidence angle of the light that is incident thereon. Since the optical member transmits and reflects light like this, the optical member causes light to travel to (i) the first side to which the light emitting element emits the light and (ii) the second side opposite to the first side.

Note here that the “second side opposite to the first side to which the light emitting element emits the light” not only means a direction completely opposite to the direction of light emission, but also means any direction somewhat deviating, toward the first side, from the direction completely opposite to the direction of light emission, provided that light is distributed to the backside of the lighting device. That is, the “second side opposite to the first side to which the light emitting element emits the light” includes, when seen from the optical member, all directions toward the backside of the lighting device.

The optical member receives the light emitted from the light emitting element and causes the light to travel to such a second side opposite to the first side, thereby distributing light in directions that are different from the direction of light emission from the light emitting element.

Meanwhile, the light emitting element is mounted on the mount part, of the holding member, which protrudes in the direction of light emission from the light emitting element.

Note here that the phrase “protrudes in the direction of light emission from the light emitting element” means that the mount part protrudes higher than the peripheral part of the holding member. For example, in the case where the holding member is divided into a protruding part and the peripheral part that surrounds the protruding part, a top surface of the protruding part serves as the mount part. The light emitting element is mounted on the mount part of the protruding part, and the protruding part protrudes higher than the peripheral part in a direction of light emission from this light emitting element. In this arrangement, it can be said that the mount part protrudes higher than the peripheral part in the direction of light emission from the light emitting element.

According to the above configuration, part of the light emitted from the light emitting element and distributed by the optical member, which part travels to the second side opposite to the first side to which the light emitting element emits the light, is partly not blocked by the peripheral part of the holding member. This makes it possible to reduce the amount of light that is blocked by the peripheral part of the holding member, and thus possible to increase the amount of light that is not blocked by the holding member but travels outward from the lighting device.

As such, according to the above configuration, it is possible to realize a lighting device capable of lighting with a wide light distribution angle by efficiently distributing light, which is emitted from a light emitting element such as an LED, also toward the backside of the lighting device.

### Advantageous Effects of Invention

According to the present invention, it is possible to provide a lighting device capable of lighting with a wide light distribution angle by distributing light, which is emitted from a light emitting element, also to a side opposite to a side to which the light emitting element emits light.

### BRIEF DESCRIPTION OF DRAWINGS

FIG. 1 is a cross-sectional view schematically illustrating a configuration of a lighting device in accordance with one embodiment of the present invention.

FIG. 2 is an external view of the lighting device.

FIG. 3 is an exploded perspective view illustrating the lighting device.

FIG. 4 is a cross-sectional view illustrating a light distribution lens of the lighting device.

FIG. 5 is a bird's-eye view illustrating the light distribution lens.

FIG. 6 is a view illustrating how a globe cover, light distribution lens, an LED module, a radiation sheet and a holding member are arranged.

FIG. 7 is a cross-sectional view illustrating a first modified example of the light distribution lens.

FIG. 8 is a bird's-eye view illustrating the first modified example of the light distribution lens.

FIG. 9 is a cross-sectional view illustrating a second modified example of the light distribution lens.

FIG. 10 is a bird's-eye view illustrating the second modified example of the light distribution lens.

FIG. 11 is a cross-sectional view illustrating a first modified example of the holding member.

FIG. 12 is a bird's-eye view illustrating the first modified example of the holding member.

FIG. 13 is a cross-sectional view illustrating second modified example of the holding member.

FIG. 14 is a bird's-eye view illustrating the second modified example of the holding member.

FIG. 15 is a cross-sectional view illustrating a third modified example of the light distribution lens.

FIG. 16 is a bird's-eye view illustrating the third modified example of the light distribution lens.

FIG. 17 is a view for explaining an effect brought about by the globe cover. (a) of FIG. 17 illustrates a comparative example of the globe cover. (b) of FIG. 17 illustrates the globe cover.

### DESCRIPTION OF EMBODIMENTS

The following description will discuss one embodiment of the present invention with reference to the drawings.

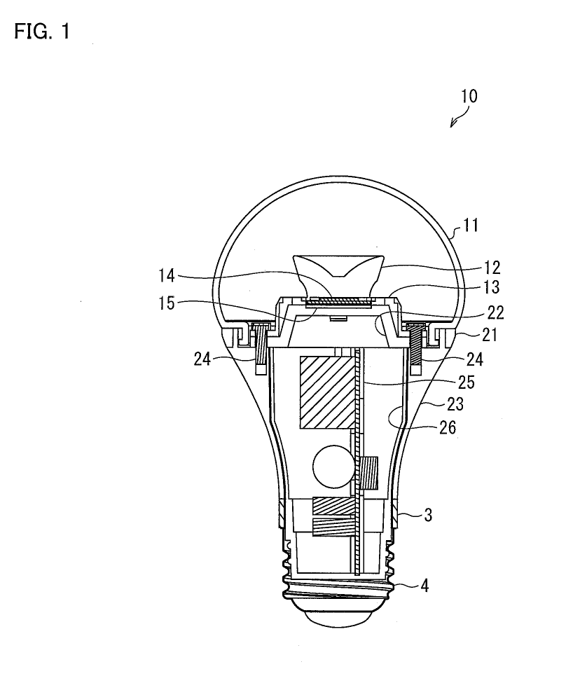

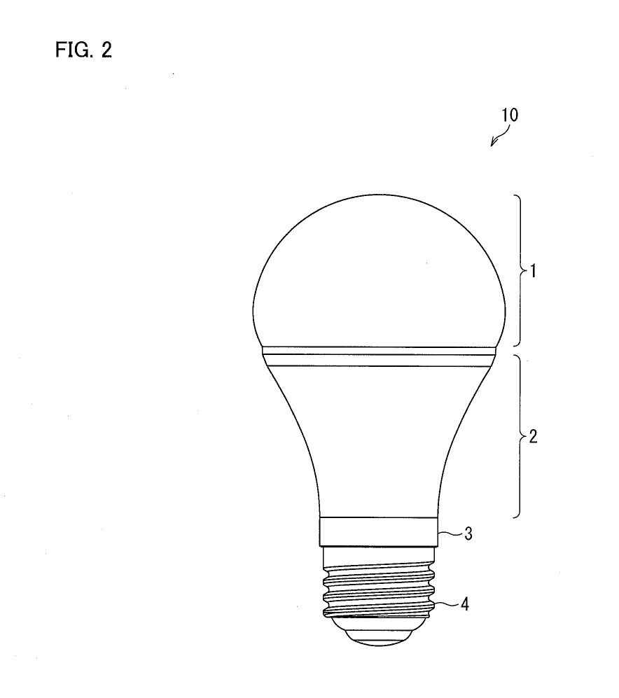

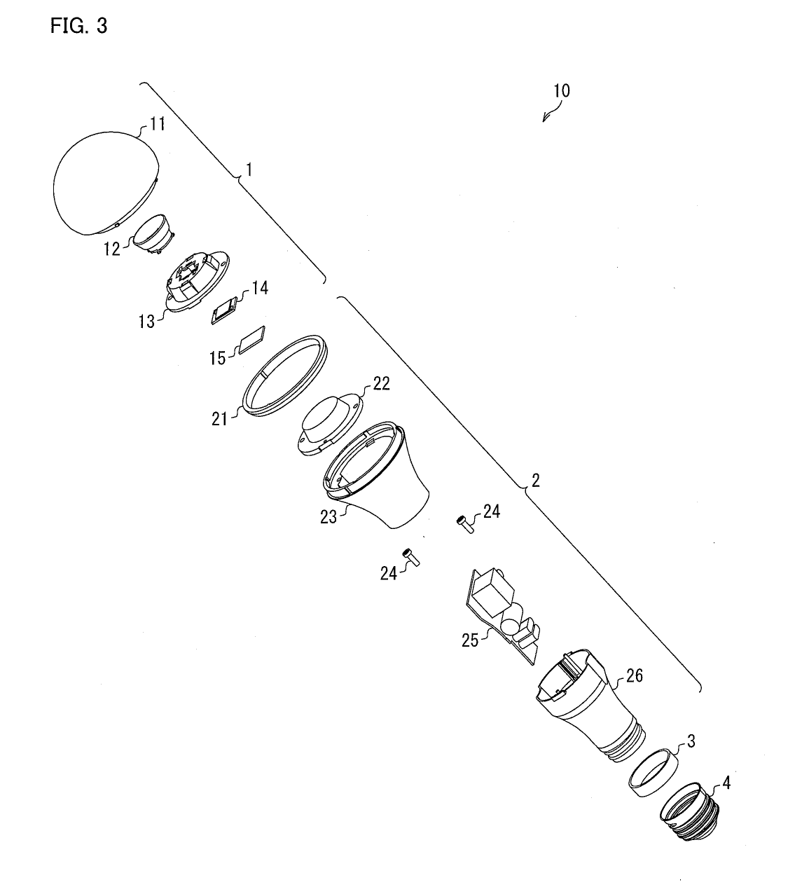

FIG. 1 is a cross-sectional view schematically illustrating a configuration of a lighting device in accordance with one embodiment of the present invention. FIG. 2 is an external view of the lighting device shown in FIG. 1 as seen from outside. FIG. 3 is an exploded perspective view schematically illustrating the configuration of the lighting device shown in FIG. 1.

(Lighting Device 10)

A lighting device 10 in accordance with one embodiment of the present invention includes, as shown in FIG. 2, a light emitting section 1, a supporting section 2, an insulation ring 3, and a base 4. Specifically, the lighting device 10 includes, as shown in FIGS. 1 and 3, the light emitting section 1, the supporting section 2, the insulation ring 3, and the base 4, which are connected in this order. Note that, for convenience of description, a side on which there is the light emitting section 1 may be hereinafter referred to as a front side of the lighting device 10, whereas a side on which there is the base 4 may be hereinafter referred to as a backside of the lighting device 10.

(Light Emitting Section 1)

The light emitting section 1 includes a globe cover (cover) 11, a light distribution lens (optical member) 12, a reflector 13, an LED module 14, and a radiation sheet 15.

(Globe Cover 11)

The globe cover 11 has a curved surface having a shape such as a hemispherical shape or a dome shape. The globe cover 11 contains therein the light distribution lens 12, the reflector 13, the LED module 14, and the radiation sheet 15, and, at the same time, covers them and is attached to the supporting section 2.

Furthermore, the globe cover 11 protects one or more LEDs mounted on the LED module 14 against external pressure and external force.

The globe cover 11 transmits light emitted from the LED(s) of the LED module 14 while diffusing and scattering part of the light. Furthermore, the globe cover 11 reflects part of the light emitted from the LED(s) so that the light travels inward. The globe cover 11 is made from, for example, glass or synthetic resin. In order for the globe cover 11 to transmit, diffuse, scatter and reflect the light emitted from the LED(s) like above, for example, a diffusing agent containing calcium as a main component may be applied to an inner surface of the globe cover 11. By adjusting the amount of the diffusing agent to be applied, it is possible to cause the glove cover 11 to have the optimal light transmittance and the optimal degree of light diffusion.

It is needless to say that such light scattering by the globe cover 11 is not the one with which the lighting device 10 achieves a wide angle of light distribution ranging from the front to the backside of the lighting device 10. It is true that more light is diffused and scattered and more light travels toward the backside of the lighting device 10 as the amount of the diffusing agent is increased. However, as the amount of the diffusing agent is increased, more of the light emitted from the LED module 14 is reflected at the globe cover 11, whereby the amount of light traveling inward from the globe cover 11 increases. That is, with the globe cover 11 to which a large amount of the diffusing agent is applied, the light emitted from the LED module 14 is repeatedly reflected inside the globe cover 11, and the light traveled inward from the globe cover 11 is absorbed by the LED module 14 and the reflector 13 etc. This means that the globe cover 11 has a low light transmittance. This leads to a reduction in beams going out of the lighting device 10.

In view of the circumstances, the lighting device 10 includes a mechanism to increase the amount of light distributed to the backside of the lighting device 10 (hereinafter, such a mechanism may be referred to as a “back distribution mechanism”) (described later). This mechanism minimizes a beam reduction that is due to a reduction in transmittance of the globe cover 11, and increases the amount of light distributed to the backside of the lighting device 10. Thereby, the mechanism realizes lighting with a wide light distribution angle.

Note that the LED module 14 generates a relatively large amount of heat when its LED(s) is/are in an ON state. Therefore, the globe cover 11 is preferably made of a heat-resistant material. The heat-resistant material is, for example, a milk white polycarbonate resin. The polycarbonate resin has excellent impact resistance, heat resistance, and light diffusing property. Therefore, the polycarbonate resin is suitable for the globe cover 11.

(Light Distribution Lens 12)

The light distribution lens 12 covers the LED module and is attached to the reflector 13. The light distribution lens 12 is, as shown in FIG. 1, in a path of the light emitted from the LED(s) of the LED module 14. Therefore, the light emitted from the LED(s) of the LED module 14 directly enters the light distribution lens 12.

The light distribution lens 12 is made of a solid material which transmits a wavelength of light that is emitted from the LED(s) of the LED module 14. The light distribution lens 12 has a lens function that is necessary for the back distribution mechanism (described later) of the lighting device 10. With the lens function, the light distribution lens 12 is capable of directing the light emitted from the LED(s) of the LED module 14 not only to the front side of the lighting device 10 but also to the backside of the lighting device 10, i.e., to a side opposite to a side to which the LED(s) of the LED module 14 emits light.

The light distribution lens 12 is provided near the LED module 14. The light emitted from the LED(s) of the LED module 14 enters the light distribution lens 12 almost without travelling through air, which is outside air. That is, a light path from the LED module 14 to the light distribution lens 12 is short, and therefore a beam reduction is small in the light path. According to such an arrangement, many beams of light enter the light distribution lens 12 from the LED module 14. This makes it possible to direct a large amount of light toward the backside of the lighting device 10, i.e., toward the side opposite to the side to which the LED module 14 emits light.

(Reflector 13)

The reflector 13 is to cause part of the light emitted from the LED(s) of the LED module 14, which part is diffused, scattered and/or reflected by the globe cover 11, to travel back toward the globe cover 11. Since the reflector 13 reflects light like this, it is possible to increase the amount of light distributed to the backside of the lighting device 10.

The reflector 13 can be made from a highly reflective resin material. Such a resin material is usually inexpensive, and therefore it is possible to produce the reflector 13 at low cost.

The reflector 13 may be produced in the following manner: a metal such as Al, brass, or stainless steel is ground into a shape as shown in FIGS. 1 and 3 with the use of a lathe or a miller etc. or shaped as shown in FIGS. 1 and 3 with a press working machine etc. and thereafter the surface of the metal is polished. It is preferable to further plate the surface with nickel (Ni) or gold (Au) so as to achieve a higher reflectance. Alternatively, as an inexpensive and simple option, a highly-reflective thin metal film such as a thin aluminum film may be attached to the surface. Another option is to (i) shape a thermoplastic resin as shown in FIGS. 1 and 3 by extrusion molding or injection molding and (ii) deposit a multilayer dielectric film or a highly-reflective thin metal film such as a thin aluminum film to the surface of the thermoplastic resin by vacuum deposition or sputtering. Alternatively, a highly-reflective white polyester film etc. may be attached to the surface.

(LED Module 14)

The LED module 14 (light emitting element) includes a plurality of LEDs and a ceramic substrate on which the plurality of LEDs are mounted. The LEDs mounted on the LED module 14 can be LEDs of various colors (wavelengths). Note however that, for lighting purposes, white LEDs are preferable because white is natural to human eyes.

The white LEDs used here can be those having various configurations. For example, it is possible to use an LED and a fluorescent material arranged such that the fluorescent material emits fluorescence upon receiving excitation light such as blue or ultraviolet light emitted from the LED. Another option is to arrange three LEDs consisting of red (R), green (G), and blue (B) LEDs so that they are close to one another like a single point source. A further option is to stack three LEDs consisting of red, green and blue LEDs on top of each other.

(Radiation Sheet 15)

The radiation sheet 15 conducts heat generated from the LEDs of the LED module 14 to a radiation member 23. The radiation sheet 15 used here is, for example, a highly heat-conductive, flame-resistant silicone gel sheet “Sarcon” (product name) (heat conductivity: 6.0 W/m·K) produced by Fuji Polymer Industries Co., Ltd.

(Supporting Section 2)

The supporting section 2 constitutes a main body of the lighting device 10, and includes a decorative ring 21, a holding member 22, the radiation member 23, a power module 25, and a holder 26.

(Decorative Ring 21)

The decorative ring 21 is a ring-shaped member separating the light emitting section 1 and the supporting section 2. The decorative ring 21 is made of, for example, a resin material. The decorative ring 21, which can have various shapes, patterns and colors, makes the lighting device 10 good-looking so that a user enjoys looking at the lighting device 10.

Alternatively, the decorative ring 21 can be made from a highly heat-conductive material such as metal, instead of the above resin material. In this case, heat generated from the LEDs of the LED module 14 is released to the outside or conducted to the radiation member 23.

The decorative ring 21 has, on its top surface, the holding member 22 fixed with screws 24. Furthermore, the top surface of the decorative ring 21 is provided with a flange on its peripheral part. To the flange, the globe cover 11 is attached.

(Holding Member 22)

The holding member 22 is a member to position and hold the LED module 14. Specifically, on an LED holding surface of the holding member 22 which surface faces toward the globe cover 11, the radiation sheet 15 and the LED module 14 are provided such that the radiation sheet 15 is sandwiched between the LED module 14 and the holding member 22. There are provided the reflector 13 and the light distribution lens 12 such that the reflector 13 is sandwiched between the light distribution lens 12 and the holding member 22.

More specifically, the holding member 22 has, on its LED holding surface, the protruding part (described later) which is necessary for the back distribution mechanism (described later) of the lighting device 10. That is, the holding member 22 has the protruding part which protrudes toward the globe cover 11. The protruding part has, on its top surface, the LED module 14 such that the LED module 14 is provided and held on the top surface. The top surface of the protruding part is preferably, for example, a continuous flat surface so that the LED module 14 is stably held on the top surface. Since the top surface is where the LED module 14 is mounted, the top surface can be regarded as a mount part on which the LED module 14 is mounted.

Since the holding member 22 has such a protruding part, it is possible to more efficiently cause the light, which has been directed by the light distribution lens 12 toward the backside of the lighting device 10, to travel to the outside of the light emitting section 1.

The holding member 22 is made of, for example, sapphire (Al₂O₃), magnesia (MgO), gallium nitride (GaN), spinel (MgAl₂O₄), iron (Fe) or the like. The holding member 22, which is made of such a material, efficiently releases heat generated by the LEDs of the LED module 14.

The holding member 22 may (i) be in the form of a plate that does not have any bent part except the protruding part or (ii) have a bent part and/or a curved part.

It is preferable that the holding member 22 has a thickness of not less than 1.0 mm but not more than 3.0 mm. If the thickness of the holding member 22 is less than 1.0 mm, the durability of the holding member 22 is not high enough to hold the LED module 14. In this case, there is a possibility that the holding member 22 cannot hold the LED module 14 over a long period of time. On the other hand, if the thickness of the holding member 22 is greater than 3.0 mm, the weight of the holding member 14 increases. This may results in cost increase.

(Radiation Member 23)

The radiation member 23 is a hollow member in the form of a tube, which contains therein the holder 26 on which the power module 25 is held. The radiation member 23 releases heat coming from heat sources such as the LED module 14 and the power module 25. For example, the radiation member 23 releases, to the outside, heat generated inside the supporting section 2. The radiation member 23 has an O-ring (not illustrated) on an outer edge of its top portion. Via the O-ring, the decorative ring 21 is fitted to the top portion of the radiation member 23 in close contact to the radiation member 23. On the bottommost portion of the radiation member 23, there is attached the insulation ring 3.

The purpose of providing the radiation member 23 is to release heat. Therefore, the radiation member 23 is preferably made from a highly heat-conductive material such as metal. For example, it is preferable that the radiation member 23 is made from: a metal such as aluminum (Al), copper (Cu), iron (Fe) or nickel (Ni); or an alloy of any of these metals. Alternatively, the radiation member 23 may be made from: an industrial material such as aluminum nitride (AlN) or silicon carbide (SiC); or a synthetic resin such as a highly heat-conductive resin.

(Power Module 25)

The power module 25 is a power circuit section that supplies electric power to the LEDs of the LED module 14. The power module 25 also serves as a control circuit section that controls lighting (e.g., color of light, amount of light) of the LEDs of the LED module 14. The power module 25 is attached inside the holder 26, and the holder 26 to which the power module 25 is attached is contained in the radiation member 23. The power module 25 is constituted by a power circuit board and a plurality of electronic components provided on both sides of the power circuit board.

The power circuit board is a printed circuit board with wires provided thereon. The electronic components are circuit components to control the lighting of the LEDs of the LED module 14. The power circuit board is preferably made from a highly heat-conductive metal such as aluminum, for better heat dissipation. Alternatively, the power circuit board may be made from a non-metal material such as a glass epoxy material or ceramics.

Each of the electronic components is, for example, a circuit component to control the lighting of the LEDs, the amount of light from the LEDs, or the color of light from the LEDs. Specifically, the electronic components include an electrolytic capacitor, a ceramic capacitor, a current transformer, a film capacitor, an REC (a rectifier, a diode bridge), a resistor, a transistor, a switching element and/or the like.

(Holder 26)

The holder 26 holds the power module 25 therein. That is, the holder 26 is a PCB holder. The holder 26 has an opening in its side surface. The power module 25 is provided inside the holder 26 such that the electronic components face the opening. With such an arrangement, heat generated from the electronic components is conducted efficiently to the radiation member 23 through the opening. The holder 26 is fixed to the decorative ring 21 at one end and to the insulation ring 3 at the other end. The holder 26 is covered with the radiation member 23. The holder 26 is preferably made from an electrical insulating, heat-conductive material. For example, the holder 26 can be made from PBT (polybutylene terephthalate), acrylic resin, ABS resin, polyamide resin or the like.

It should be noted that an internal space defined by the supporting section 2 and the insulation ring 3 may be filled with a potting compound. This electrically insulates the power module 25 and causes the power module 25 to be fixed inside the radiation member 23. Furthermore, the potting compound conducts, to the radiation member 23, heat generated from the power module 25 in the supporting section 2 and heat generated from the LED module 14. Therefore, the potting compound is preferably made from a highly heat-conductive resin. For example, the potting compound can be made from a highly heat-conductive, electrical insulating, heat-resistant synthetic resin such as silicone resin, epoxy resin or urethane resin.

(Insulation Ring 3)

The insulation ring 3 is made from an electric insulating material. The uppermost portion of the insulation ring 3 is attached to the bottommost portion of the radiation member 23. The insulation ring 3 has a thread ridge on its outer surface, whereby the insulation ring 3 is screwed into and attached to the base 4.

(Base 4)

The base 4 is a metal part for connection with an external part. The base 4 is, for example, a generally-used E26 base. Specifically, the base 4 supplies, to the power module 25, electric power supplied from an external power source (not illustrated). The base 4 has, on its inner surface, a thread ridge that fits the thread ridge on the outer surface of the insulation ring 3. This allows the insulation ring 3 to be screwed into and attached to the base 4. That is, the thread ridge on the inner surface of the base 4 is a screw mechanism for screw connection between the base 4 and the insulation ring 3.

The base 4 has a screw thread also on its outer surface. This allows the lighting device 10 to be screwed into and attached to a socket which is provided in a ceiling etc.

(Back Distribution Mechanism)

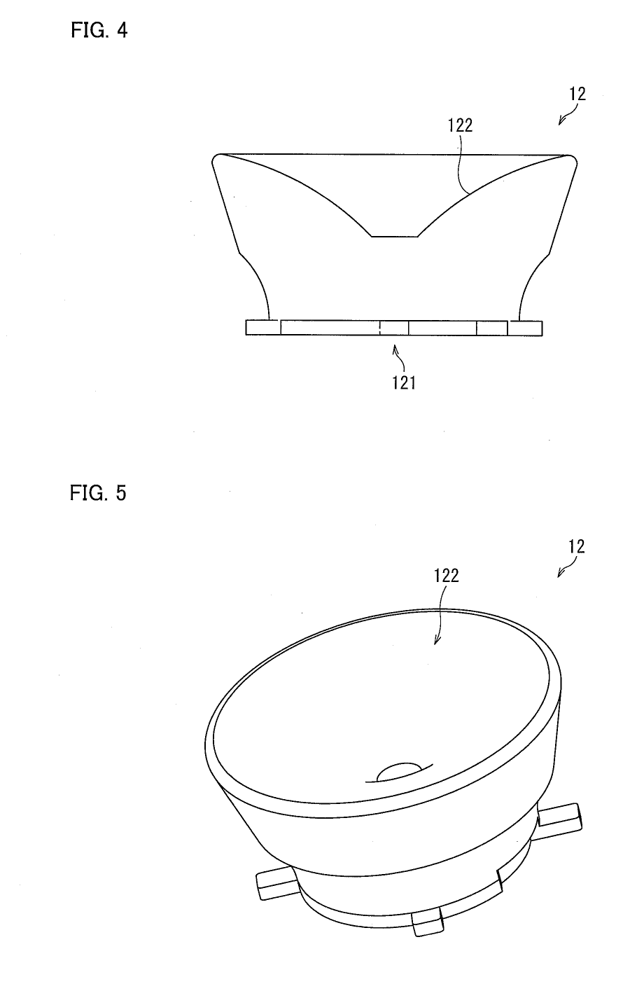

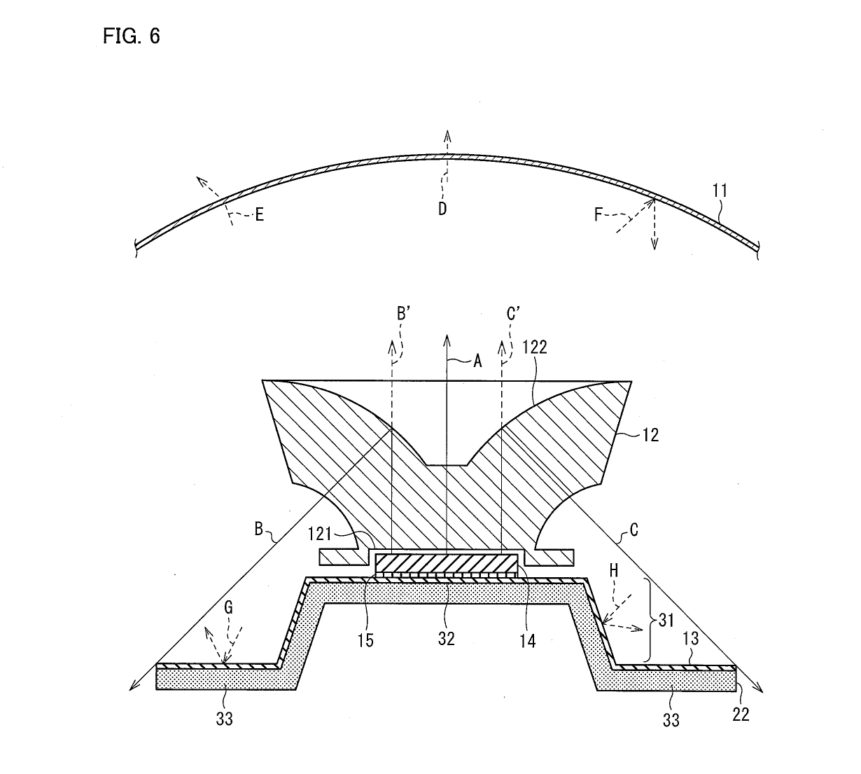

The following description discusses the back distribution mechanism, which is a feature of the present invention, of the lighting device 10 with reference to FIGS. 4, 5 and 6. FIG. 4 is a cross-sectional view illustrating the light distribution lens 12. FIG. 5 is a bird's-eye view illustrating the light distribution lens 12. FIG. 6 is a view schematically illustrating how the globe cover 11, the light distribution lens 12, the LED module 14, the radiation sheet 15 and the holding member 22 are arranged. It should be noted that FIG. 6 illustrates these constituents merely schematically, and that the relative sizes etc. of the constituents may be different from actual ones.

According to the back distribution mechanism, light emitted from the LEDs of the LED module 14 is directly incident on a light entrance surface (bottom surface) 121, which faces the LED module 14, of the light distribution lens 12 (see FIG. 6). The light, which has been incident on the light entrance surface 121, keeps travelling through the light distribution lens 12 toward a light distribution surface (top surface) 122 of the light distribution lens 12. The light distribution surface 122 faces the light entrance surface 121, and distributes the light which has entered the light distribution lens 12 through the light entrance surface 121.

The following describes the light distribution surface 122. For example, light represented by arrow A in FIG. 6 enters the light distribution lens 12 through the light entrance surface 121, and keeps traveling in the same direction to pass through the light distribution surface 122. That is, the light represented by arrow A travels along a direction of light emission from the LEDs of the LED module 14 and goes out of the light distribution lens 12.

On the other hand, light represented by arrow B in FIG. 6 enters the light distribution lens 12 through the light entrance surface 121 and keeps traveling along the direction of light emission until it reaches the light distribution surface 122. The light represented by arrow B is then reflected at the light distribution surface 122, without passing through the light distribution surface 122. Note, here, that it is needless to say that there also exists light represented by B′ in FIG. 6, that is, light that reaches the light distribution surface 122 and passes through the light distribution surface 122 without being reflected at the light distribution surface 122.

Similarly, light represented by arrow C in FIG. 6 enters the light distribution lens 12 through the light entrance surface 121 and keeps traveling along the direction of light emission until it reaches the light distribution surface 122. The light represented by arrow C is reflected at the light distribution surface 122, without passing through the light distribution surface 122. Note also here that there also exists light represented by arrow C′ in FIG. 6, that is, light that reaches the light distribution surface 122 and passes through the light distribution surface 122 without being reflected at the light distribution surface 122.

That is, the light distribution surface 122 is not a total reflection surface, but is a surface that reflects, refracts and transmits light emitted from the LEDs of the LED module 14.

Note here that the holding member 22 has, as described earlier, the protruding part 31. The protruding part 31 has, on its top surface (in other words, mount part) 32, the LED module 144. With the configuration, the light represented by arrow B and the light represented by arrow C travel to the outside of the light emitting section 1 without being blocked by the holding member 22.

That is, if, for example, the holding member 22 does not have such a protruding part 31 and is in the form of a flat plate, the light represented by arrow B and the light represented by arrow C are blocked by the holding member 22. Therefore, even if the light distribution lens 12 directs the light toward the backside of the lighting device 10, it is not likely that the light travels to the outside of the light emitting section 1.

As described above, according to the back distribution mechanism of the lighting device 10, since the LED module 14 is provided on the top surface of the protruding part 31 of the holding member 22, it is possible to effectively cause the light, which is directed by the light distribution lens 12 toward the backside of the lighting device 10, to travel out of the light emitting section 1.

In other words, the back distribution mechanism allows for efficient use of the light distribution lens 12 which has the following lens function. That is, the lens function is to direct, toward the backside of the lighting device 10, light that travels in the direction of light emission from the LEDs of the LED module 14, i.e., light that travels toward the front side of the lighting device 10.

Note here that the height of the protruding part 31, in other words, to what degree the protruding part 31 protrudes from the supporting member 22, should be determined according to the power of the lens function of the light distribution lens 12. That is, the height of the protruding part 31 (to what degree the protruding part 31 protrudes from the supporting member 22) is not limited, provided that the light, which has been directed by the lens function of the light distribution lens 12 toward the backside of the lighting device 10, goes out of the light emitting section 1 without being blocked by the holding member 22. That is, it is only necessary that the light, which travels from the light distribution lens 12 toward the backside of the lighting device 10, travel beyond the peripheral part 33 of the holding member 22.

By determining the height of the protruding part 31 in the above manner, it is possible to avoid making a higher-than-necessary protruding part 31. This allows the LED module 14 to be held more stably.

Furthermore, the light distribution lens 12 and the globe cover 11 do not become too close to each other. The light distribution surface 122 of the light distribution lens 12 can be regarded as a light-emitting point when viewed from the outside of the lighting device 10, because the light distribution surface 122 distributes light in various directions. Therefore, if the light distribution lens 12 is close to the glove cover 11, this means that the light-emitting point is close to the globe cover 11. Usually, when the light-emitting point is close to the globe cover 11, a striped pattern is seen through the globe cover 11. This may bother a user very much who looks at the lighting device 10 at a distance.

In the back distribution mechanism of the lighting device 10, there is provided the protruding part 31. The protruding part 31 is part of the holding member 22, and is a bump with a sloping surface. Since there is the protruding part 31, it is possible to cause the peripheral part of the holding member 22 to be closer to the base (to be more distant from the light distribution lens 12) while ensuring such a distance between the glove cover 11 and the distribution lens 12 that no striped pattern appears. This makes it possible to achieve a wide angle of light distribution ranging from the front to the backside of the lighting device 10, without causing the globe cover 11 and the light distribution lens 12 to be too close to each other. Therefore, no striped pattern is seen through the globe cover 11.

That is, the lighting device 10 is arranged such that (i) the light distribution surface 122 (which serves as a light-emitting point) of the light distribution lens 12 is positioned downstream from the mount part 32 along the direction of light emission from the LEDs and (ii) the light distribution lens 12 causes light to travel from the light distribution surface 122 to a side opposite to a side to which the LEDs emit light (see FIG. 6). This causes more of the light to travel to the base 4 side beyond the peripheral part 33 of the holding member 22, and thus makes it possible to obtain a wide angle of light distribution that ranges from the front to the backside of the lighting device 10.

Furthermore, since the mount part 32 protrudes higher than the peripheral part 33 of the holding member 22 in the direction of light emission from the LEDs, the light distribution surface 122 is positioned more downstream along the direction of light emission, that is, the light distribution surface 122 is more distant from the peripheral part 33 of the holding member 22. This makes it possible to reduce the proportion of light that is blocked by the holding member 22.

Furthermore, the lighting device 10 is arranged such that, in order for the light distribution surface 122 (which serves as a light-emitting point) to be positioned more downstream along the direction of light emission, the mount part 32 protrudes higher than the peripheral part of the holding member 22. Therefore, it is not necessary to increase the height of the light distribution lens 12 along the direction of light emission. This makes it possible to reduce the length of the path of light that travels through the light distribution lens 12. Accordingly, beams of light that pass through the light distribution lens 12 decrease to a lesser extent, and therefore light use efficiency is improved.

The back distribution mechanism of the lighting device 10 also brings about the following effects.

Light that has passed through the light distribution surface 122 of the light distribution lens 12 and light that has been reflected at the light distribution surface 122 of the light distribution lens 12 both travel toward the globe cover 11 and eventually reach the globe cover 11. For example, light represented by arrow D in FIG. 6 passes through the globe cover 11 and goes out of the light emitting section 1.

The direction of travel of light represented by arrow E in FIG. 6 is changed when the light passes through the globe cover 11, because the light is diffused when passing through the globe cover 11. It is needless to say that such a change in the direction of travel also contributes to an improvement in the light-distribution property of the lighting device 10.

On the other hand, light represented by arrow F in FIG. 6 is reflected without passing through the globe cover 11. In this case, the light travels back inward from the globe cover 11. As described earlier, the holding member 22 has the reflector 13 on its LED holding surface. The light, which has been reflected at the globe cover 11 and is travelling back inward from the glove cover 11, is reflected again by, for example, the reflector 13, and then travels back toward the globe cover 11.

Since reflection is repeated like above, the light distributed by the light distribution lens 12 travels at various angles. This contributes to an improvement in the light-distribution property of the lighting device 10.

The globe cover 11 is preferably configured such that its maximum diameter, which is a diameter perpendicular to the direction of light emission from the LED module 14, is larger than the diameter of the peripheral part 33 of the holding member 22. In this case, the globe cover 11 can be divided into the following two parts by a plane that is perpendicular to the direction of light emission from the LED module 14 and includes the maximum diameter: an upper part positioned downstream along the direction of light emission from the LED module 14; and a lower part positioned upstream along the direction of light emission from the LED module 14. The lower part is on the holding member 22 side, and its diameter range includes the diameter of the peripheral part 33 of the holding member 22.

Since the maximum diameter of the globe cover 11 is larger than the diameter of the peripheral part 33 of the holding member 22, the lower part of the globe cover 11 is positioned under the upper part. In other words, the lower part is positioned upstream from the upper part along the direction of light emission.

Accordingly, light diffused by the lower part of the globe cover 11 shines also on a side opposite to a side to which the LED module 14 emits light. This achieves a wider angle of light distribution.

(Modified Example of Light Distribution Lens 12)

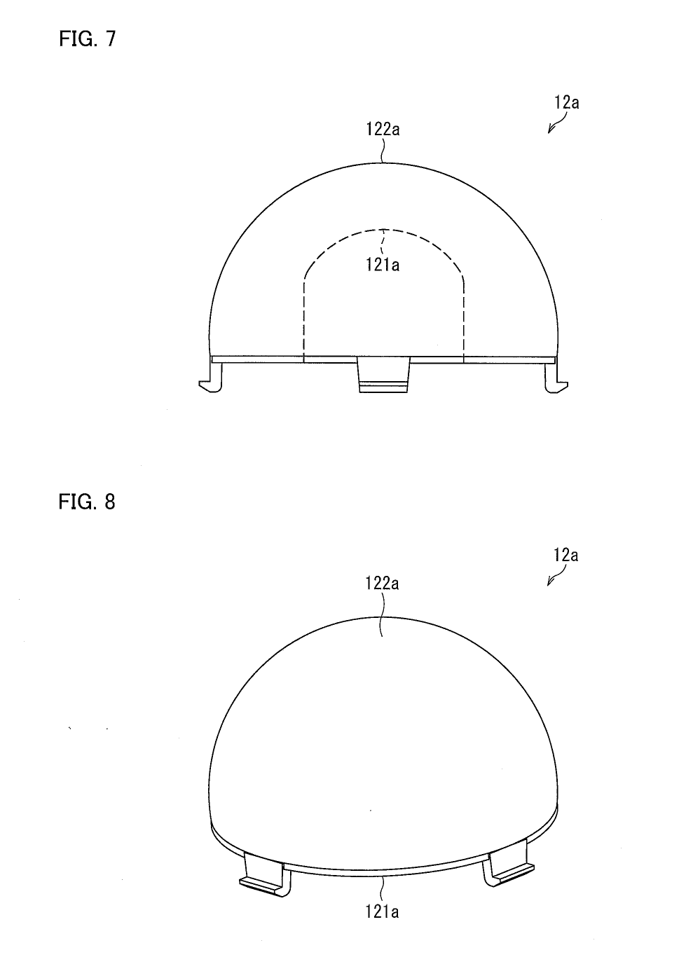

FIG. 7 is a cross-sectional view illustrating a light distribution lens 12a, which is a first modified example of the light distribution lens 12. FIG. 8 is a bird's-eye view illustrating the light distribution lens 12a shown in FIG. 7. The light distribution lens 12a has (i) a light entrance surface 121a which corresponds to the light entrance surface 121 of the light distribution lens 12 and (ii) a light exit surface 122a which corresponds to the light distribution surface 122 of the light distribution lens 12.

The light distribution lens 12a is different from the light distribution lens 12 in that the light entrance surface 121a and the light exit surface 122a each transmit or reflect light depending on whether the incidence angle of the light is greater than a specific angle unique thereto.

That is, the light distribution lens 12a achieves, with a combination of the light entrance surface 121a and the light exit surface 122a, a lens function equivalent to that of the light distribution lens 12.

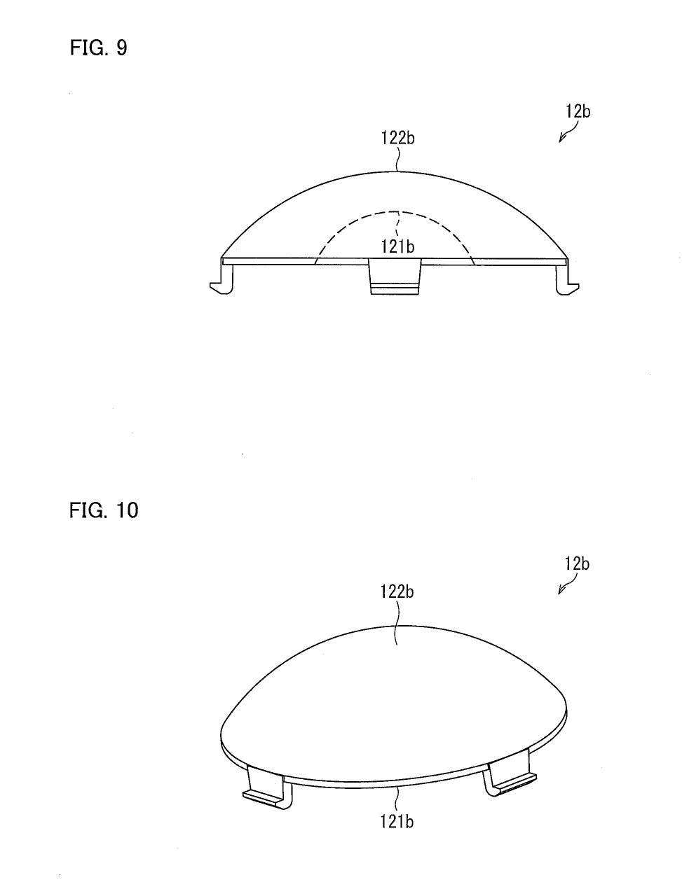

Similarly, FIG. 9 is a cross-sectional view illustrating a light distribution lens 12b, which is a second modified example of the light distribution lens 12. FIG. 10 is a bird's-eye view illustrating the light distribution lens 12a shown in FIG. 9. The light distribution lens 12b has (i) a light entrance surface 121b which corresponds to the light entrance surface 121 of the light distribution lens 12 and (ii) a light exit surface 122b which corresponds to the light distribution surface 122 of the light distribution lens 12.

As is the case with the light distribution lens 12a, the light distribution lens 12b also achieves, with a combination of the light entrance surface 121b and the light exit surface 122b, a lens function equivalent to that of the light distribution lens 12.

(Modified Example of Holding Member 22)

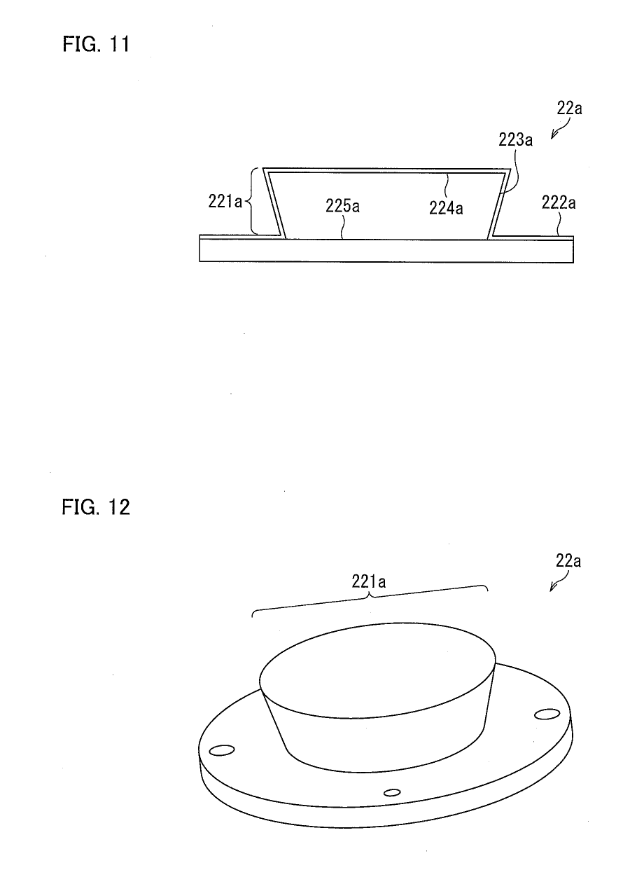

FIG. 11 is a cross-sectional view illustrating a holding member 22a, which is a first modified example of the holding member 22. FIG. 12 is a bird's-eye view illustrating the holding member 22a shown in FIG. 11. The holding member 22a has a protruding part 221a, which corresponds to the protruding part 31 of the holding member 22. The holding member 22a has a reflector 222a thereon, which corresponds to the reflector 13.

The holding member 22a is different from the holding member 22 in that a side surface 223a of the protruding part 221a is inclined, from a top surface 224a to a bottom surface 225a, toward the center of the protruding part 221a. The holding member 22 is arranged such that the side surface of the protruding part 31 is inclined, from the bottom surface to the top surface 32, toward the center of the protruding part 31.

In other words, the holding member 22a is arranged such that the top surface 224a of the protruding part 221a is larger in area than the bottom surface 225a of the protruding part 221a, whereas the holding member 22 is arranged such that the top surface 32 of the protruding part 31 is smaller in area than the bottom surface of the protruding part 31.

Since the area of the top surface (mount part) 224a on which the LED module 14 is mounted is large, it is possible to cause more light to be reflected at the top surface 224a so that the light travels upward (in the direction of light emission from the LED module 14).

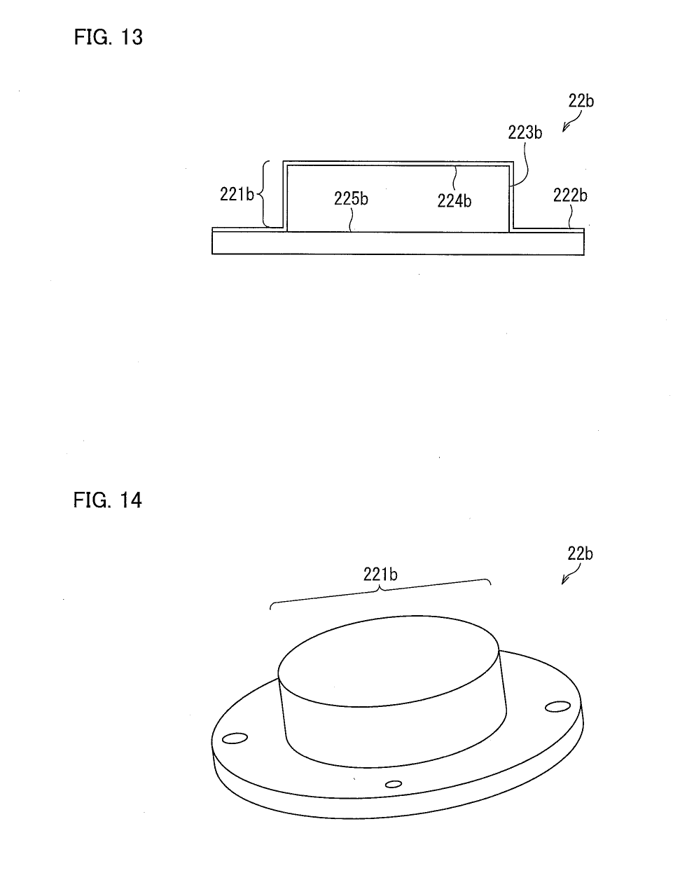

FIG. 13 is a cross-sectional view illustrating a holding member 22b, which is a second modified example of the holding member 22. FIG. 14 is a bird's-eye view illustrating the holding member 22b shown in FIG. 13. The holding member 22b has a protruding part 221b, which corresponds to the protruding part 31 of the holding member 22. The holding member 22b has a reflector 222b thereon, which corresponds to the reflector 13.

The holding member 22b is different from the holding member 22 in that a side surface 223b of the protruding part 221b is not inclined, from a top surface 224b to a bottom surface 225b, toward the center of the protruding part 221b. The holding member 22 is arranged such that the side surface of the protruding part 31 is inclined, from the bottom surface to the top surface 32, toward the center of the protruding part 31.

In other words, the holding member 22b is arranged such that the top surface 224b of the protruding part 221b has the same area as the bottom surface 225b of the protruding part 221b, whereas the holding member 22 is arranged such that the top surface 32 of the protruding part 31 is smaller in area than the bottom surface of the protruding part 31.

Note that a modified example of the holding member 22 does not necessarily have to have a protruding part as described above. For example, the holding member may be in the shape of a truncated cone having a trapezoidal cross section. The holding member having such a shape also makes it possible, by having the LED module 14 on its top surface, to position the LED module 14 more downstream along the direction of light emission from the LED module 14 to thereby cause light to travel to the backside of the lighting device 10.

(Alternative to Light Distribution Lens 12)

As has been described, the light distribution lens 12 has the lens function of changing the direction of part of light emitted from the LEDs of the LED module 14 so that the part of the light travels toward the backside of the lighting device 10. In other words, the lens function can be replaced with some other member(s), provided that the member(s) is/are capable of diffusing the light from the LEDs of the LED module 14 in various directions.

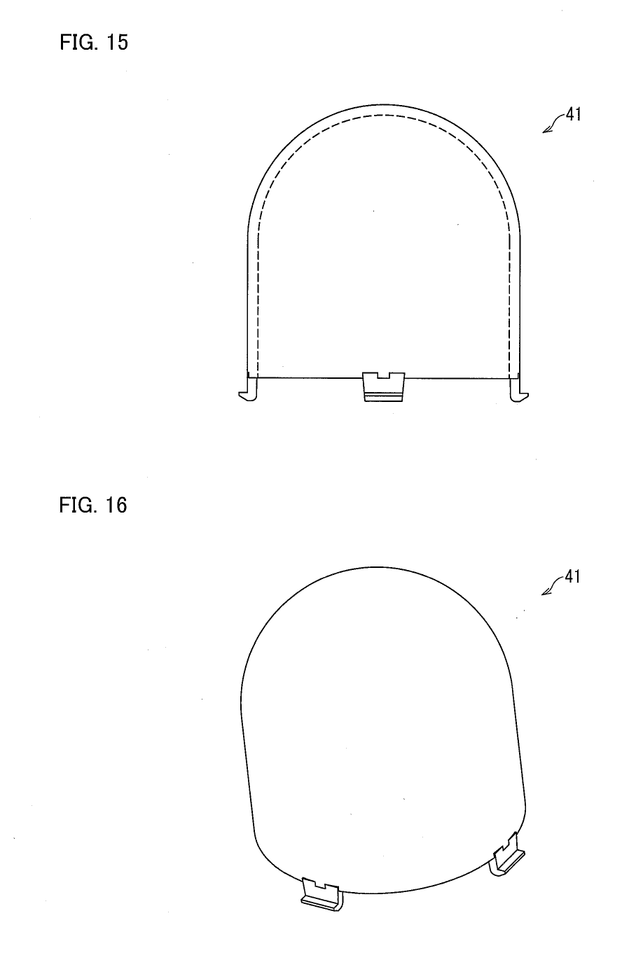

FIGS. 15 and 16 are views illustrating a diffusion cover for use in a known night-light bulb. FIG. 15 is a cross-sectional view of the diffusion cover. FIG. 16 is a bird's-eye view of the diffusion cover.

Such a diffusion cover can be used instead of the light diffusion lens 12 to achieve a function equivalent to the lens function of the light distribution lens 12. That is, by using the diffusion cover and the globe cover 11 in combination, it is possible to diffuse highly-directional light from the LED module 14 in two steps, and thus possible to achieve wider light distribution.

Note, however, that the diffusion cover is to diffuse light emitted from a bulb provided therein so that the light thus diffused travels in various directions. Therefore, the diffusion cover may reduce beams of light depending on the degree of light diffusion.

In view of the circumstances, in the case of using the diffusion cover instead of the light distribution lens 12, it is necessary to make sure that the diffusion cover is the one that provides an appropriate degree of light diffusion. This is because, even though the diffusion cover achieves an improved light distribution property, a lighting device that cannot provide a desired amount of beams cannot be used as a lighting device.

(Effect Brought about by Globe Cover 11)

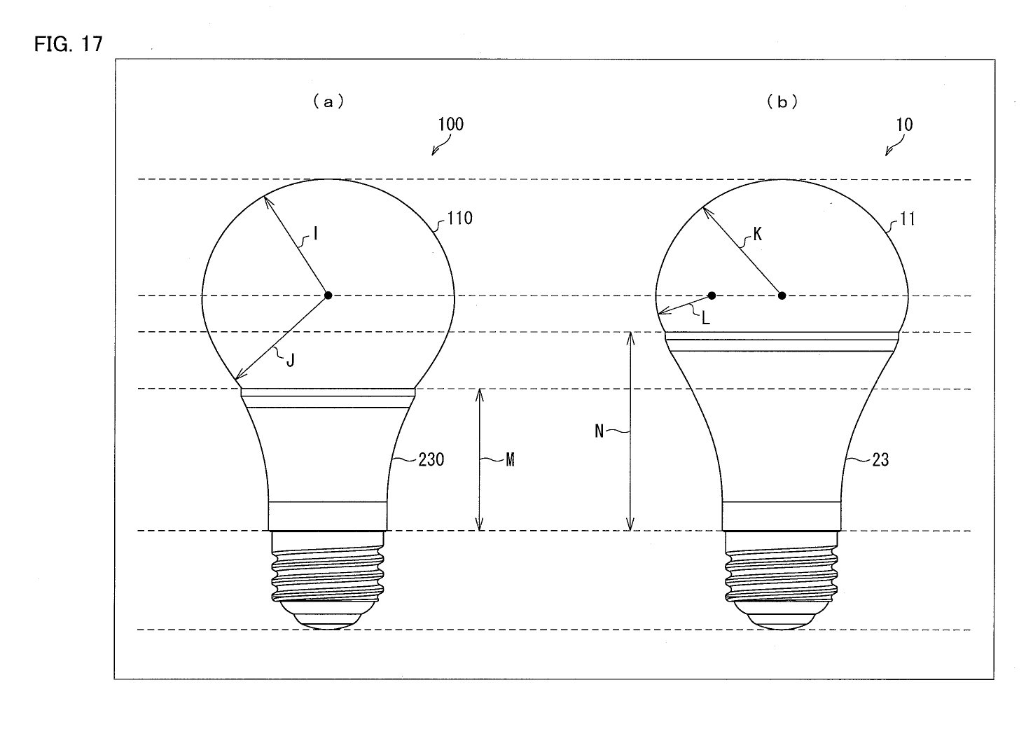

The following description discusses an effect brought about by the globe cover 11 with reference to FIG. 17. (a) of FIG. 17 is a view illustrating a comparative example of the globe cover 11. (b) of FIG. 17 is a view illustrating the globe cover 11.

As illustrated in (b) of FIG. 7, the globe cover 11 has a curved surface. Specifically, the curved surface is defined by the following two radii of curvature: a radius of curvature K and a radius of curvature L. That is, the curved surface of the globe cover 11 is made up of (i) a first curved surface defined by the radius of curvature K and (ii) a second curved surface defined by the radius of curvature L. What effect is brought about by such a structure will be evident from a comparison between such a structure and the comparative example shown in (a) of FIG. 17.

A globe cover 110 of a lighting device 100 shown in (a) of FIG. 17 is made up of (i) a first curved surface defined by a radius of curvature I and (ii) a second curved surface defined by a radius of curvature J. Note, however, that the radius of curvature I and the radius of curvature J are the same radii of curvature that share a common center of curvature. That is, as is clear from (a) of FIG. 17, the globe cover 110 has a substantially spherical shape.

Because of such a difference in shape, the two lighting devices 10 and 100 have the following differences.

In general, the total length of a lighting device is specified by a standard etc. and thus cannot be freely changed. That is, each constituent of the lighting device is limited as to its size depending on the predetermined total length.

Comparing the globe cover 11 with the globe cover 110, the globe cover 11 has two different radii of curvature and therefore accounts for a smaller proportion of the total length of the lighting device 10 than the globe cover 110. This means that other constituents can have a larger size.

Making good use of such an advantage, the lighting device 10 has a large radiation member 23 so that heat is released more efficiently from the lighting device 10. Specifically, the radiation member 23 (length N of the radiation member 23) of the lighting device 10 is longer than a radiation member 230 (length M of the radiation member 230) of the lighting device 100. This provides more efficient heat dissipation.

Although the description above dealt with a large-size radiation member 23, it is needless to say that it is also possible to increase the size of other constituent(s).

The present invention is not limited to the description of the embodiments above, but may be altered by a skilled person within the scope of the claims. An embodiment based on a proper combination of technical means altered within the scope of the claims is encompassed in the technical scope of the present invention.

The lighting device in accordance with one embodiment of the present invention is preferably configured such that the optical member causes the light to travel toward a peripheral part of the holding member.

According to the configuration, it is possible to direct the light from the optical member toward the peripheral part of the holding member. This makes it possible to efficiently distribute the light emitted from the light emitting element toward the backside of the lighting device, and thus possible to realize a lighting device capable of lighting with a wide light distribution angle.

The lighting device in accordance with one embodiment of the present invention preferably further includes a cover which (i) covers the light emitting element, the holding member and the optical member and (ii) transmits the light emitted from the light emitting element, and is configured such that a maximum diameter, which is perpendicular to the direction of light emission from the light emitting element, of the cover is larger than a diameter of the peripheral part of the holding member.

According to the configuration, the cover can be divided into an upper part and a lower part by a plane that is perpendicular to the direction of light emission from the light emitting element and includes the maximum diameter. The upper part is positioned downstream along the direction of light emission from the light emitting element, whereas the lower part is positioned upstream along the direction of light emission from the light emitting element. The lower part is on the holding member side, and its diameter range includes the diameter of the peripheral part of the holding member.

Note here that, when the maximum diameter of the cover is larger than the diameter of the peripheral part of the holding member, the lower part of the part is positioned under the upper part. In other words, the lower part is positioned upstream from the upper part along the direction of light emission.

Accordingly, light diffused by the lower part of the cover shines also on the second side opposite to the first side to which the light emitting element emits light. This achieves a wider angle of light distribution.

The lighting device in accordance with one embodiment of the present invention is preferably configured such that the cover includes: a first curved surface which is on a light emitting element side; and a second curved surface which is continuous with the first curved surface and is upstream from the first curved surface along the direction of light emission from the light emitting element, the second curved surface being defined by a smaller radius of curvature than the first curved surface.

According to the configuration, the cover can be divided into (i) the first curved surface positioned on the light emitting element side and (ii) the second curved surface that is continuous with the first surface and is positioned upstream from the first curved surface along the direction of light emission from the light emitting element.

Since the second curved surface is defined by a radius of curvature smaller than that of the first curved surface, the second curved surface is positioned under the first curved surface. In other words, the second curved surface is positioned upstream from the first curved surface along the direction of light emission from the light emitting element.

As such, according to the above configuration, light diffused by the lower part of the cover shines also on the second side opposite to the first side to which the light emitting element emits light. This achieves a wider angle of light distribution.

The lighting device in accordance with one embodiment of the present invention is preferably configured such that the holding member is provided with a reflector which reflects light that is emitted from the light emitting element and reflected at the cover.

According to the configuration, light that is reflected at the cover without passing through the cover is reflected again at the reflector, and travels back to the cover. Accordingly, it is possible to cause the light distributed by the optical member to travel at various angles, and thus possible to realize a lighting device capable of lighting with a wider light distribution angle.

The lighting device in accordance with one embodiment of the present invention is preferably configured such that the light emitting element is an LED.

The configuration makes it possible to realize a more long-life, power-saving lighting device.

### REFERENCE SIGNS LIST

3 Insulation ring
4 Base
10 Lighting device
11 Globe cover (cover)
12 Light distribution lens (optical member)
13 Reflector
14 LED module (light emitting element(s))
15 Radiation sheet
21 Decorative ring
22 Holding member
23 Radiation member
24 Screw
25 Power module
26 Holder
31 Protruding part

1. A lighting device, comprising:
a light emitting element;
a holding member which holds the light emitting element on its mount part, the mount part protruding in a direction of light emission from the light emitting element; and
an optical member which faces toward the mount part, the optical member (i) receiving light emitted from the light emitting element and (ii) causing the light to travel to a first side to which the light emitting element emits the light and to a second side opposite to the first side.

2. The lighting device according to claim 1, wherein the optical member causes the light to travel toward a peripheral part of the holding member.

3. A lighting device according to claim 1, further comprising a cover which (i) covers the light emitting element, the holding member and the optical member and (ii) transmits the light emitted from the light emitting element,
wherein a maximum diameter, which is perpendicular to the direction of light emission from the light emitting element, of the cover is larger than a diameter of the peripheral part of the holding member.

4. The lighting device according to claim 3, wherein the cover includes:
a first curved surface which is on a light emitting element side; and
a second curved surface which is continuous with the first curved surface and is upstream from the first curved surface along the direction of light emission from the light emitting element, the second curved surface being defined by a smaller radius of curvature than the first curved surface.

5. The lighting device according to claim 3, wherein the holding member is provided with a reflector which reflects light that is emitted from the light emitting element and reflected at the cover.

6. The lighting device according to claim 1, wherein the light emitting element is an LED.
